(19) United States
(12) Patent Application Publication
(10) Pub. No.: US 2016/0014390 A1
(43) Pub. Date: Jan. 14, 2016

(54) Electronic Devices With Connector Alignment Assistance

(71) Applicant: Apple Inc., Cupertino, CA (US)

(72) Inventors: Christiaan A. Ligtenberg, San Carlos, CA (US); David G. Conroy, El Granada, CA (US)

(21) Appl. No.: 14/326,366

(22) Filed: Jul. 8, 2014

(51) Int. Cl. H04N 13/02; G08B 5/36

(52) U.S. Cl. CPC H04N 13/0203; G08B 5/36

(57) ABSTRACT

An electronic device may have input-output ports. The electronic device may have control circuitry and input-output devices. The input-output devices may include sensors, camera equipment, and other input devices that the control circuitry uses to monitor the location of the plug relative to the input-output port. The input-output devices may also include a display, light-emitting diode array, speaker, or other visual or audio output device. The control circuitry can use the output device to provide a user with plug alignment assistance information. The plug alignment assistance information can be provided visually, using audio, or using other output. Plug alignment assistance information can include information that helps the user align the plug with a port and may be based on information on the location of the plug relative to the input-output ports and based on information on which ports are available.

### BACKGROUND

This relates generally to electronic devices and, more particularly, to electronic devices that have connector ports coupled to cables and other accessories.

Electronic devices such as computers generally have input-output ports. Cables may be used to attach peripherals to the input-output ports. For example, when it is desired to attach a peripheral such as printer to a computer, one end of a cable may be plugged into the printer and the other end of the cable may be plugged into an input-output port on the computer.

Input-output ports are typically located on rear portions of a computer to hide the ports and the cables that are coupled to the ports from view by a user of the computer. Although it is desirable to locate input-output ports on the rear of a computer from an aesthetic standpoint, doing so poses challenges when it is necessary to plug cables into the ports. The rear of the computer may be located close to a wall or other obstruction that restricts access. As a result, it may be difficult or impossible for a user to view the input-output ports on a computer while attempting to plug cables into these ports. The inability to clearly view the input-output ports can make proper insertion of a cable into a suitable port a frustrating trial-and-error process. These difficulties can be magnified for ports that only accept plugs in a particular orientation, because a user may not be able to tell whether a plug is failing to mate with a port because the plug is offset from the plug or because the plug is misoriented.

It would therefore be desirable to be able to provide ways in which to assist a user when plugging cables or other accessories into the input-output ports of an electronic device.

### SUMMARY

An electronic device may be provided with a housing. The housing may have a front face and a rear face. A display or other visual output device may be located on the front face. Input-output ports may be mounted on the rear face or other portion of the housing.

The electronic device may have control circuitry and input-output devices. The input-output devices may include sensors, camera equipment, and other resources that the control circuitry uses to monitor the location of the plug relative to the input-output port.

The input-output devices may also include a display such as a display on the front face of the housing, a light-emitting diode array such as a light-emitting diode array on the front face of the housing, a speaker, or other visual or audio output device. The control circuitry can use the output device to provide a user with plug alignment assistance information. The plug alignment assistance information can be provided visually, using audio, or using other output.

Plug alignment assistance information can include information that helps the user align the plug with a port and may be based on information on the location of the plug relative to the input-output ports and based on information on which ports are available.

### BRIEF DESCRIPTION OF THE DRAWINGS

FIG. 1 is a perspective view of an illustrative electronic device such as a computer, computer monitor, or other equipment with a display in accordance with an embodiment.

FIG. 2 is a perspective view of an illustrative electronic device such as a set-top box, computer, or other equipment that has been coupled to a display using a cable.

FIG. 3 is a schematic diagram of an illustrative electronic device that may be coupled to an external accessory using a plug that mates with an input-output port in the electronic device in accordance with an embodiment.

FIG. 4 is a top view of an illustrative electronic device of the type shown in FIG. 1 showing how an external plug may be plugged into an input-output port on the rear of the electronic device in accordance with an embodiment.

FIG. 5 is a side view of the illustrative electronic device of FIG. 4 in accordance with an embodiment.

FIG. 6 is a perspective view of an illustrative plug being aligned with an input-output port in an array of input-output ports on the rear of an electronic device in accordance with an embodiment.

FIG. 7 is a diagram showing alignment assistance information that may be displayed on the front of a device for a user while the user attempts to align a plug with an input-output port on the rear of the device in accordance with an embodiment.

FIG. 8 is a diagram showing alignment assistance information that may be displayed for a user when it has been determined that the plug a user is attempting to plug into an input-output port has been rotationally misaligned with respect to an input-output port on the rear of a device in accordance with an embodiment.

FIG. 9 is a cross-sectional side view of an input-output port in which a sensor or communications circuitry associated with the input-output port is being used to detect the presence of a connector in the port in accordance with an embodiment.

FIG. 10 is a diagram showing alignment assistance information that may be displayed on the front of a device to indicate to a user which input-output ports on the rear of the device are occupied, which are available, and where a plug is currently located with respect to the available input-output ports.

FIG. 11 is a diagram showing alignment assistance information that may be displayed on the front of a device to indicate to a user which input-output ports on the rear of the device are available and where a plug is currently located with respect to the available input-output ports.

FIG. 12 is a perspective view of an illustrative electronic device having an array of light-emitting diodes that provide visible alignment assistance information to a user when the user is inserting a plug into an input-output port on the rear of the electronic device in accordance with an embodiment.

FIG. 13 is a front view of an illustrative portion of an electronic device of the type shown in FIG. 12 showing how the light-emitting diode array may be mounted behind an array of perforations in a housing for the electronic device in accordance with an embodiment.

FIG. 14 is a diagram showing how sensors or other components may be used to gather information about the location of a plug relative to input-output ports in an electronic device in accordance with an embodiment of the present invention.

FIG. 15 is a diagram showing how a plug may provide light or other output that is sensed by sensors associated with input-output ports to determine how the plug is aligned with respect to the input-output ports in accordance with an embodiment.

FIG. 16 is a diagram showing how signal sources such as light sources or acoustic signal sources and corresponding detectors may be used in measuring where a plug is located relative to input-output ports in accordance with an embodiment.

FIG. 17 is a diagram showing how an array of electrodes may be used in gathering information on the location of a plug relative to input-output ports in accordance with an embodiment.

FIG. 18 is a cross-sectional side view of an illustrative portion of an electronic device showing how a signal source and signal detector adjacent to an input-output port such as a light source and light detector may be used in monitoring where a plug is located relative to the input-output port in accordance with an embodiment.

FIG. 19 is a diagram showing how camera equipment may be used in monitoring where a plug is located relative to the input-output port and how a plug is oriented relative to the input-output port in accordance with an embodiment.

### DETAILED DESCRIPTION

An electronic device may have input-output ports. Devices with connectors may be plugged into the input-output ports. The input-output ports may be located on the rear of a device or other location that is difficult to view. To help a user who is interested in plugging a connector into one of the input-output ports, the electronic device may provide on-screen information on where a plug is located relative to the input-output ports or may provide other connector alignment assistance. The connector alignment assistance may be visual information, audio information, or other feedback that helps the user align the plug with respect to an appropriate input-output port on the device.

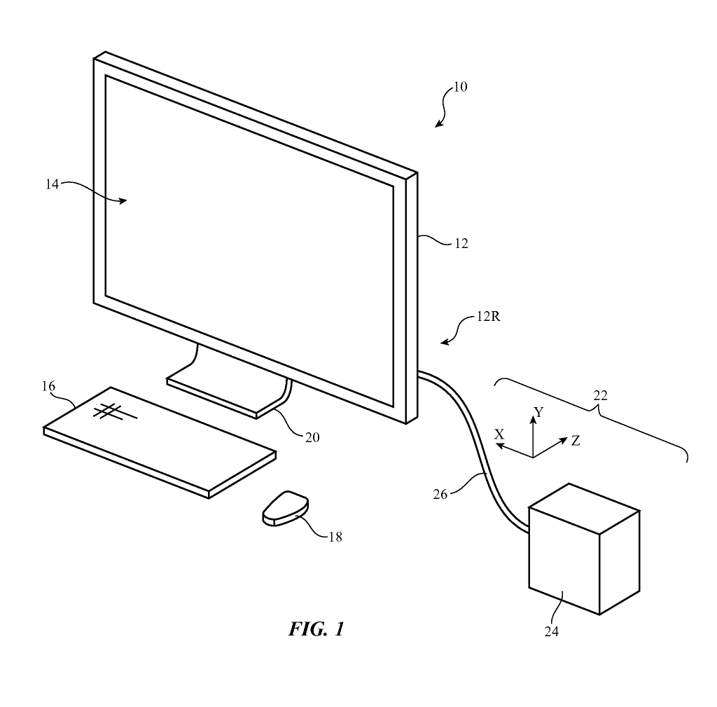

An illustrative electronic device of the type that may provide a user with connector alignment assistance is shown in FIG. 1. Electronic device 10 may have a housing such as housing 12. A display such as display 14 may be mounted in housing 12.

Housing 12, which may sometimes be referred to as an enclosure or case, may be formed of plastic, glass, ceramics, fiber composites, metal (e.g., stainless steel, aluminum, etc.), other suitable materials, or a combination of any two or more of these materials. Housing 12 may be formed using a unibody configuration in which some or all of housing 12 is machined or molded as a single structure or may be formed using multiple structures (e.g., an internal frame structure, one or more structures that form exterior housing surfaces, etc.).

Display 14 may be a touch screen display that incorporates a layer of conductive capacitive touch sensor electrodes or other touch sensor components (e.g., resistive touch sensor components, acoustic touch sensor components, force-based touch sensor components, light-based touch sensor components, etc.) or may be a display that is not touch-sensitive. Capacitive touch screen electrodes may be formed from an array of indium tin oxide pads or other transparent conductive structures. Display 14 may include an array of display pixels formed from liquid crystal display (LCD) components, an array of electrophoretic display pixels, an array of plasma display pixels, an array of organic light-emitting diode display pixels, an array of electrowetting display pixels, or display pixels based on other display technologies.

Accessories such as keyboard 16 and mouse 18 may be used to provide input to display 14. Stand 20 may be used to support housing 12 and display 14. If desired, device 10 may be mounted on a wall (e.g., stand 20 may be omitted). Accessories such as accessory 22 may be coupled to input-output ports on device 10. The input-output ports may be located on the rear of housing 12 (i.e., on rear face 12R of housing 12) or elsewhere in device 10. Accessory 22 may be a printer, a data storage device, a keyboard, a touch pad, stylus tablet, a mouse, a music keyboard, a scanner, a camera, a video camera, an ancillary display, audio equipment, a digital media reader such as a card reader, a memory key, a wireless dongle, or other electronic device. Accessory 22 may have a connector. The connector may located at the end of a cable such as cable 26 or may be formed as part of accessory housing 24. Accessory connectors, which may sometimes be referred to as plugs, may be male connectors, female connectors, reversible connectors, connectors that have a particular orientation, connectors that have both male and female portions. Configurations in which accessory 22 has a male connector are sometimes described herein as an example. In general, accessory 22 may have any suitable plug for mating with a corresponding connector in an input-output port of device 10.

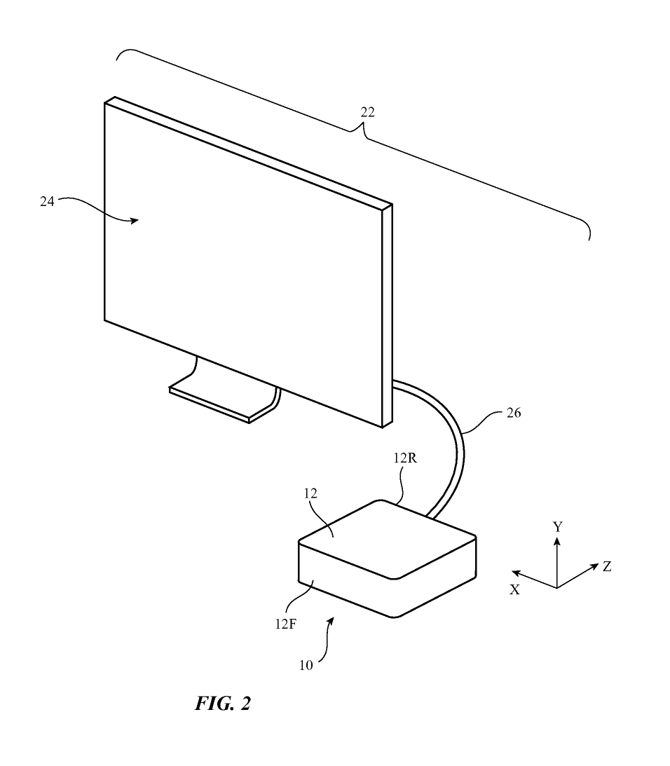

As shown in the illustrative configuration of FIG. 2, accessory 22 may be an external display such as display 24 that is coupled to electronic device 10 by cable 26. In this type of configuration, electronic device 10 may not have its own display. A plug at the end of cable 26 may mate with an input-output port in the rear of device 10 (e.g., on rear face 12R of housing 12). Light-emitting diodes or other output devices may, if desired, be located on opposing front face 12F or other visible portion of device 10.

Electronic device 10 may, in general, be a computing device such as a laptop computer, a computer monitor containing an embedded computer, a tablet computer, a cellular telephone, a media player, or other handheld or portable electronic device, a smaller device such as a wrist-watch device, a pendant device, a headphone or earpiece device, a device embedded in eyeglasses or other equipment worn on a user's head, or other wearable or miniature device, a television, a computer display that does not contain an embedded computer, a gaming device, a navigation device, an embedded system such as a system in which electronic equipment with a display is mounted in a kiosk or automobile, equipment that implements the functionality of two or more of these devices, or other electronic equipment. The illustrative electronic devices of FIGS. 1 and 2 are merely illustrative.

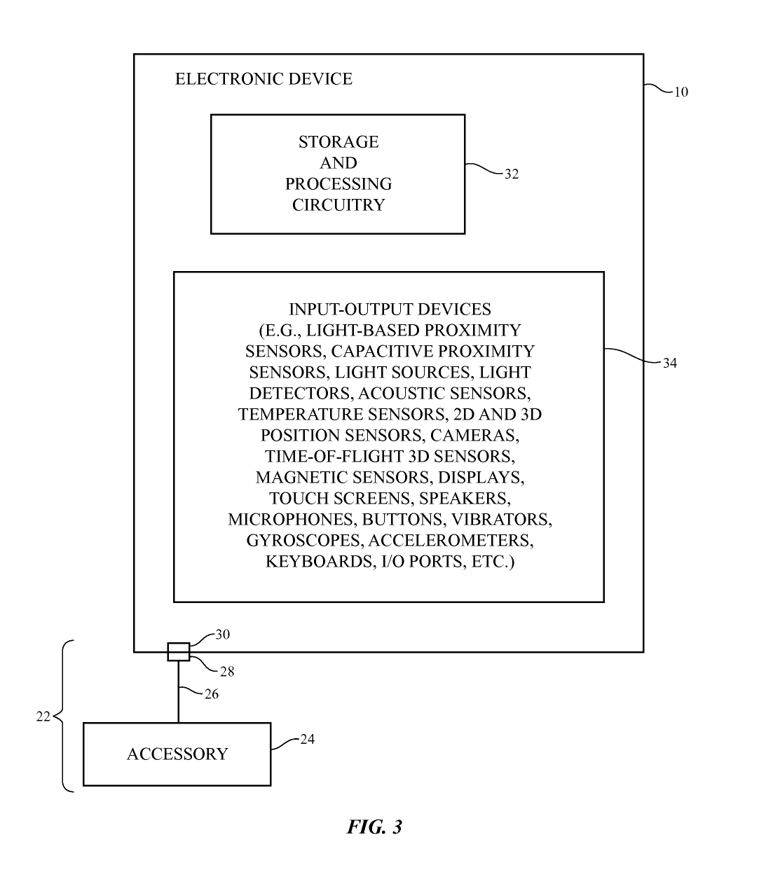

A schematic diagram of electronic device 10 and accessory 22 is shown in FIG. 3. As shown in FIG. 3, plug 28 of accessory 22 may be located at the end of cable 26 and may mate with a corresponding connector in one or more input-output ports in device 10 such as input-output port 30. If desired, plug 28 may be integrated with housing 24 of accessory 24 (e.g., when accessory 22 is a memory key, a wireless dongle, or other compact device in which cable 26 has been omitted).

Device 10 may include control circuitry such as storage and processing circuitry 32. Storage and processing circuitry 32 may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in storage and processing circuitry 32 may be used to control the operation of device 10. This processing circuitry may be based on one or more microprocessors, microcontrollers, digital signal processors, baseband processor integrated circuits, application specific integrated circuits, etc.

Control circuitry such as storage and processing circuitry 32 may be used to run software on device 10, such as internet browsing applications, email applications, media playback applications, operating system functions, software for processing data from input devices, software for providing a user with information using output devices, etc.

Device 10 may include input-output devices 34. Input-output devices 34 may be used to allow data to be supplied to device 10 and to allow data to be provided from device 10 to external devices. One or more input devices in input-output devices 34 (e.g., sensors, cameras, etc.) may be used to gather input on the location of plug 28. One or more output devices in input-output devices 34 (e.g., visual output devices such as displays or light-emitting diodes, audio output devices, etc.) may provide visual and/or audio output to a user (e.g., plug alignment assistance).

Input-output devices 34 may include communications port circuitry for communicating with external equipment such as accessory 22 via input-output port 30 and plug 28. Input-output devices 34 may also include user interface devices and other circuitry for gathering input and for providing output to a user. For example, input-output devices may include touch screens, displays without touch sensor capabilities, buttons, joysticks, scrolling wheels, touch pads, key pads, keyboards, microphones, acoustic sensors, cameras and other imaging systems for capturing two-dimensional and/or three-dimensional images, speakers, status indicators, light-emitting diodes and other light sources, light sensors, accelerometers or other components that can detect motion and device orientation relative to the Earth, capacitance sensors, proximity sensors (e.g., a capacitive proximity sensor and/or an infrared proximity sensor), magnetic sensors, a connector port sensor or other sensor that determines whether plug 28 has been plugged into port 30, temperature sensors (thermal sensors), etc.

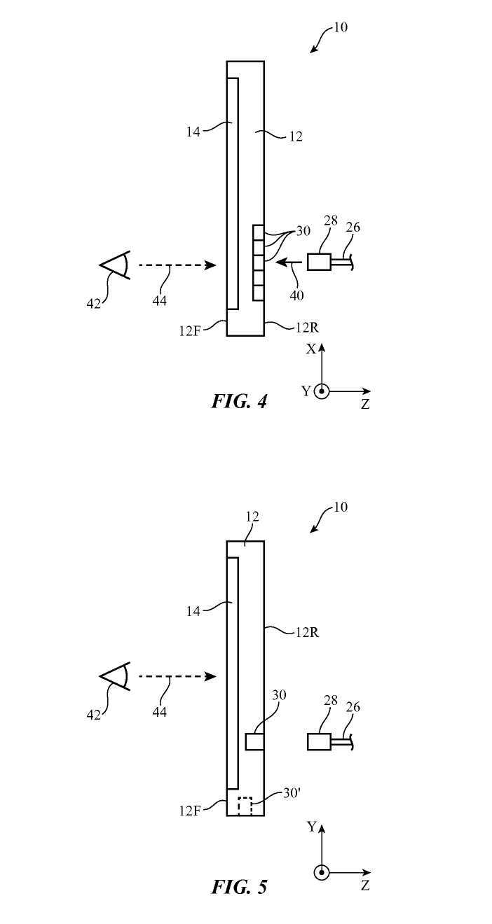

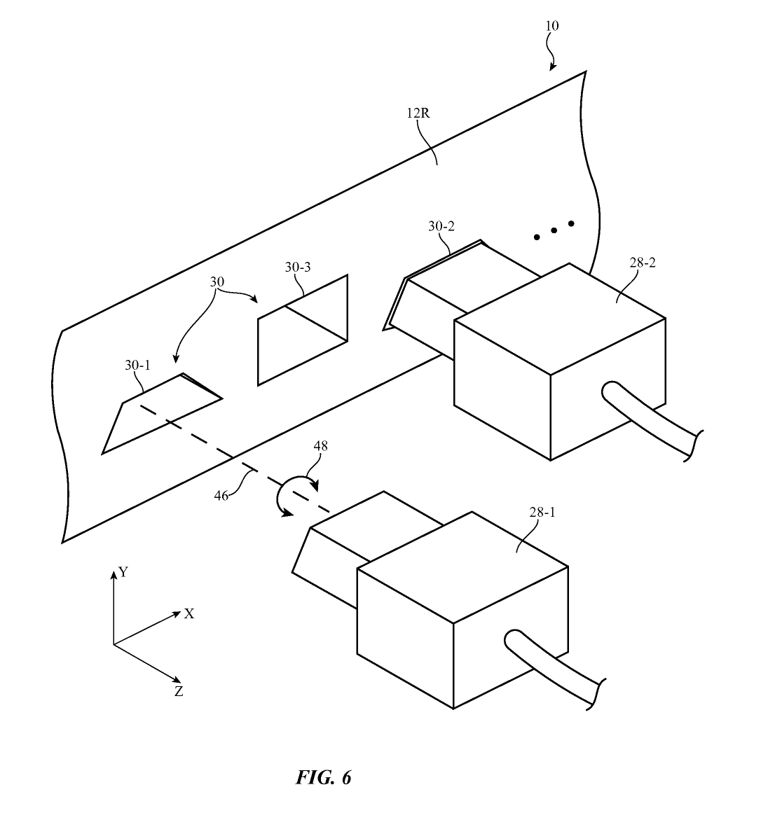

FIG. 4 is a top view of an illustrative electronic device such as device 10 of FIG. 1. As shown in FIG. 4, a user such as user 42 may view display 14 on view front face 12F of device 10 in direction 44. Input-output ports 30 may be hidden from view on rear face 12F of housing 12 of device 10. Because input-output ports 30 are not visible to the user (when the user is positioned in the location shown in FIG. 4), it may be challenging to position plug 28 correctly relative to an available input-output port 30. For example, a user may laterally misalign plug 28 in horizontal dimension X and/or vertical dimension Y while attempting to insert plug 28 into one of ports 30. As shown in FIG. 5, input-output ports 30 may be arranged in a row at a particular vertical location (in dimension Y) on rear 12R of housing 12. If desired, input-output ports 30 may be located on other portions of device 10 (see, e.g., port position 30′ on the lower edge 12L of housing 12 of FIG. 5) or may be located in a two-dimensional array, may be located in two or more different locations in device 10.

FIG. 6 is a perspective view of a rear portion of device 10 showing an illustrative array of input-output ports 30. In the example of FIG. 6, plug 28-1 is being inserted into available input-output port 30-1. Plug 28-1 and port 30-1 can only be successfully coupled when plug 28-1 is in the position shown in FIG. 6 (i.e., when plug 28-1 is properly aligned in lateral dimensions X and Y and when plug 28-1 is rotationally aligned with port 30-1 by rotating plug 28-1 in directions 48 about rotational axis 46).

Ports 30 may include any suitable types of input-output ports such as Universal Serial Bus (USB) ports or other digital data ports, audio ports such as headphone and microphone ports (e.g., ports using ⅛″ connectors such as tip-ring-sleeve connectors or tip-ring-ring-sleeve connectors), Thunderbolt ports, DisplayPort ports or other ports for digital display connectors, Ethernet ports or other networking ports, or other ports.

In the FIG. 6 example, ports 30 include two ports that are orientation sensitive (ports 30-1 and 30-2). These ports can only be used when a mating plug has been placed in its correct orientation. Misoriented plugs (i.e., plugs that have inadvertently been rotated about rotational axis 48 by 180°) will not fit. Plug 28-1 also cannot be inserted into ports that are already occupied. For example, plug 28-1 cannot be inserted into port 30-2 even though port 30-2 is the correct type of port for receiving plug 28-1, because port 30-2 is already occupied by plug 28-2. Input-output ports may also include ports are not appropriate for receiving plug 28-1 because they are not designed for the same type of connector. For example, port 30-3 is free (unoccupied) because it is not currently occupied by any plugs, but is not available for receiving plug 28-1, because plug 28-1 has an asymmetric shape, whereas plug 30-3 has a symmetrical rectangular shape (in this example).

Particularly when a user is unable to view ports 30, it can be difficult to insert a plug such as plug 28-1 into a satisfactory mating port. It can be difficult to laterally align plug 28-1 to port 30-1, it can be difficult to rotationally align plug 28-1 to port 30-1, it can be difficult to determine whether plug 28-1 is oriented properly with respect to port 30-1 (i.e., to determine whether plug 28-1 is right-side up or upside down, etc.), it can be difficult to determine which ports are unoccupied, and it can be difficult to determine which ports are of the same type as plug 28-1.

These issues can be addressed by providing a user of device 10 with plug (connector) alignment assistance. Plug alignment assistance information can be provided visually, audibly, using text, using graphics, using information on a display, using audio information presented through speakers, using tones, using vibrations, using synthesized or recorded audio clips (e.g., spoken instructions), using light-emitting diodes or other status indicator lights, using an array of light-emitting diodes (e.g., light-emitting diodes located behind corresponding perforations in display 12), or using combinations of these approaches. During operation of device 10 (e.g., after display 14 on the front of device 10 has been powered, but before plug 28 has been satisfactorily inserted in an available input-output port 30), cameras, sensors, or other equipment may be used in gathering input on the location of plug 28 relative to ports 30. Ports 30 can also be analyzed to determine which ports are of the same type as plug 28 and are not currently occupied by other plugs.

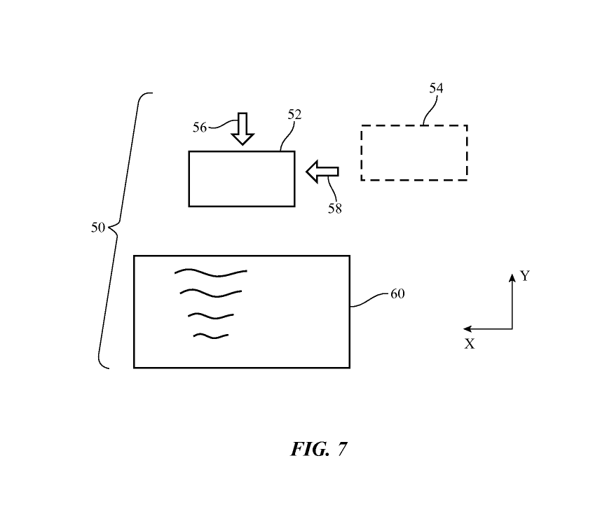

Based on information on the relative position of plug 28 and available port(s) 30, device 10 (e.g., storage and processing circuitry 32) may determine how plug 28 should be moved to successfully align plug 28 with port 30 and thereby insert plug 28 into port 30. Consider, as an example, a situation in which plug 28 is laterally misaligned with respect to input-output port 30. In this type of situation, device 10 may display information on display 14 or other visual output device (e.g., an array of light-emitting diodes, etc.) such as visual alignment assistance information 50 of FIG. 7.

Alignment assistance information 50 may include a visual representation of the location of port 30 such as port location indicator 52 and a visual representation of plug 28 such as plug location indicator 54. Port location indicator (icon) 52 and plug location indicator (icon) 54 may be placed at locations on display 14 on the front of device 10 that are proportional to the relative positions of plug 28 and port 30 on the hidden rear of device 10. If desired, direction indicators may be displayed to indicate to the user the direction in which plug 28 should be moved to align plug 28 with port 30.

In the FIG. 7 example, plug 28 is located above port 30 and to the right of port 30. Accordingly, device 10 has displayed alignment assistance in the form of left direction indicator 58 (e.g., a left-pointing arrow) and down direction indicator 56 (e.g., a downwardly pointing arrow). When a user observes the presence of left arrow 58, the user is informed that plug 28 should be moved to the left. When the user observes down arrow 52, the user is informed that plug 28 should be moved down. Direction indicators (sometimes referred to as lateral translation indicators) such as indicators 56 and 58 may be updated continuously in real time. For example, if a user overshoots port 30 during alignment, the direction of the direction indicator may be changed to show the user that the plug should be moved in the opposite direction. Once plug 28 has been satisfactorily aligned with port 30, plug location indicator 54 will be aligned with port location indicator 52 and the user can proceed to insert plug 28 into port 30.

If desired, the visual alignment assistance information can include additional information such as additional information 60. Information 60 may include text, graphics, video (e.g., a video clip or an animation), or other supplemental information. As an example, text may be displayed that states “move plug to left” or “move plug to right” until alignment is achieved. Once plug 28 and port 30 have been satisfactorily aligned, text may be displayed that states “insert plug now.” Upon confirmation of successful insertion of the plug, text may be displayed that states “plug inserted correctly” to confirm to the user that the plug insertion process has been completed successfully. Information 60 may also contain information about the location of available ports (e.g., “all ports occupied already” or “two USB ports available”), may contain a video clip of an instructor providing useful guidance on the plug insertion process or other device setup operations.

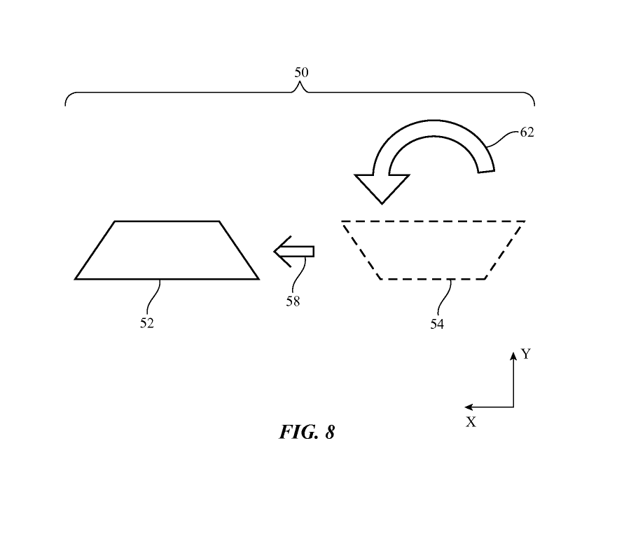

In some situations, a user may misorient plug 28 (i.e., when plug is an orientation-specific plug that can only be used in one orientation). For example, plug 28 may be an orientation-specific plug that is rotationally misaligned by 180° with respect to port 30. In this situation, plug 28 is flipped relative to the proper orientation for plug insertion, so the user will not be able to insert plug 28 into port 30 even if plug and port 30 are laterally aligned. To help the user properly orient plug 28 relative to port 30, visual alignment assistance 50 of the type shown in FIG. 8 may be displayed. As shown in the example of FIG. 8, visual alignment assistance 50 may include an indicator such as rotational indicator 62 that directs the user to rotate plug 28 by 180° about rotational axis 46 (FIG. 6) to align plug 28 with the input-output port. Lateral translation indicators may also be provided (see, e.g., direction indicator 58). If desired, text or other information may be used to instruct the user to properly orient plug 28. As an example, device 10 may display visual assistance information such as text stating “please rotate the connector by 180° to properly orient the connector with respect to the available input-output port.” Visual indicators of the relative positions of port 30 (e.g., indicator 52) and plug 28 (e.g., indicator 54) may also be provided. These indicators may visually represent the rotationally asymmetric shape of the plug and port.

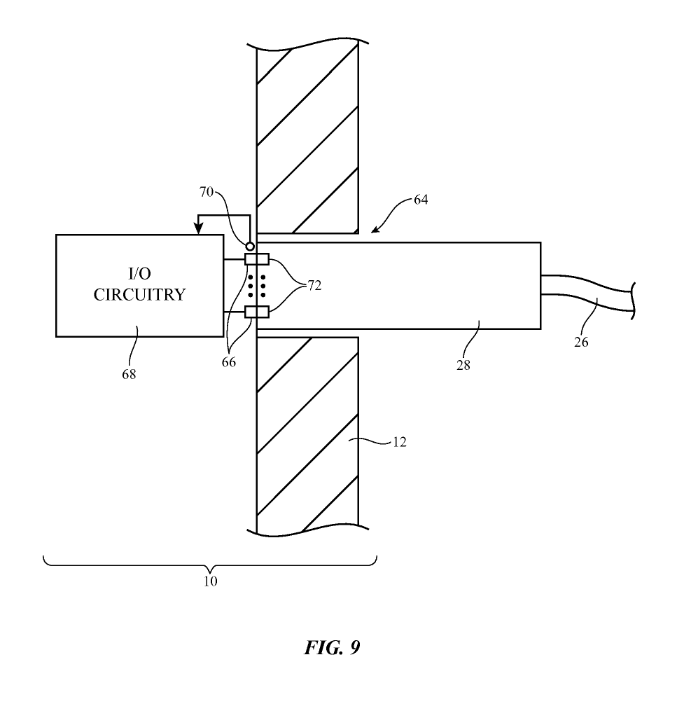

It may be desirable for device 10 to obtain knowledge of which ports are available and which ports are occupied by plugs. The presence and absence of plugs can be detected using plug sensors, by monitoring for communications traffic on each port, or other techniques. Consider, as an example, port 30 of FIG. 9. As shown in FIG. 9, input-output port 30 may be formed in opening 64 in housing 12 and may have an associated connector with contacts (pins) such as contacts 66. When plug 28 is mated with port 30, pins 66 of port 30 are each connected to a corresponding pin (contact) 72 in plug 28. Within device 10, contacts 66 may mate with signal lines associated with input-output circuitry 68.

Input-output circuitry 68 may include digital data port circuitry (e.g., USB communications circuitry), audio circuitry, or other storage and processing circuitry 30 or circuitry associated with input-output devices 34 (FIG. 3). During operation, device 10 can monitor signal activity on circuitry 68 to determine whether port 30 is active and therefore contains plug 28.

If desired, sensors such as sensor 70 may be used in monitoring for the presence of plugs in port 30. Sensor 70 may be a contact switch that is actuated whenever plug 28 is inserted into opening 64, may be a magnetic sensor that detects the presence of a magnet in plug 28, may be a magnetic sensor that detects electromagnetic signals associated with the flow of signals and currents through port 30, may be a capacitive sensor or light-based sensor that detects the presence and absence of plug 28 or may be implemented using other suitable plug presence detection sensor arrangements.

Device 10 may have multiple input-output ports 30 each of which has a corresponding input-output circuit such as circuit 68 of FIG. 9 and/or a corresponding sensor 70. Control circuitry in device 10 can use input-output circuitry and/or sensors 70 to determine which input-output ports 30 are occupied and can use this information in presenting alignment assistance information for a user of device 10.

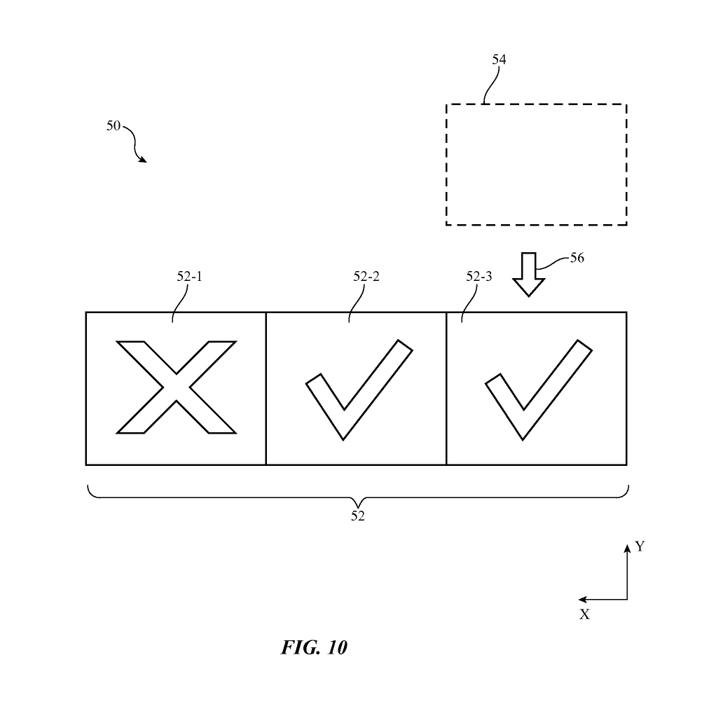

FIG. 10 is a diagram of visual assistance information 50 that may be presented to a user who is using an electronic device with three input-output ports 30, two of which are unoccupied and one of which is occupied. Alignment assistance information 50 may include a visual representation of the location of input-output ports 30. For example, alignment assistance information 50 may include a port indicator such as indicator 52 that shows the user where input-output ports 30 are located in lateral dimensions X and Y. In the FIG. 10 example, indicator 52-1 corresponds to the location of a first input-output port 30, indicator 52-1 corresponds to the location of a second input-output port 30, and indicator 52-3 corresponds to the location of a third input-output port 30. Port location information such as information 52 may include information on the occupancy status of each port. Symbols, text, colors, or other visual representations may be used to indicate which ports currently contain plugs and which ports are free. As an example, port indicator 52-1 may contain an “X” symbol to indicate that a plug is currently plugged into the first input-output port. Port indicators 52-2 ad 52-3 may contain a check mark symbol to indicate that no plugs are currently plugged into the second and third input-output ports so that the second and third ports are available to receive plug 28. A plug location indicator such as plug location indicator 54 may be included in alignment assistance information 50 to indicate where plug 28 is currently located relative to ports 30. Directional indicators or other information that informs the user of the direction in which plug 28 should be moved to align plug 28 with a port 30 may be displayed (see, e.g., down arrow 56). If desired, device 10 may use knowledge of which ports are available (e.g., the second and third ports in this example) so that directional arrows such as arrow 56 only point towards available ports.

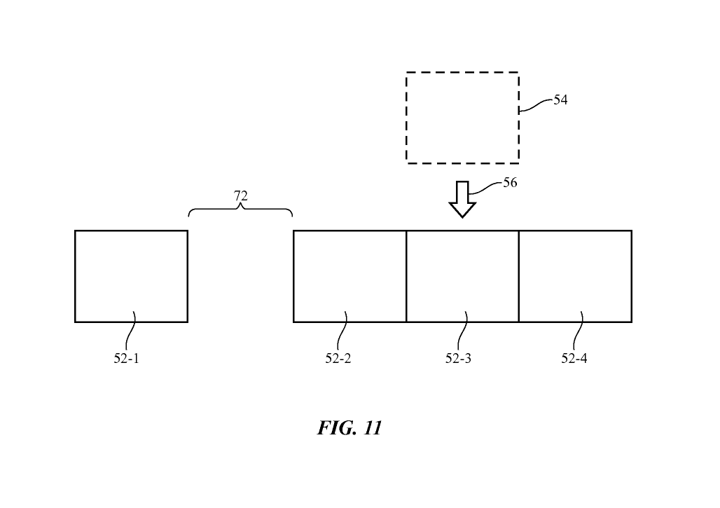

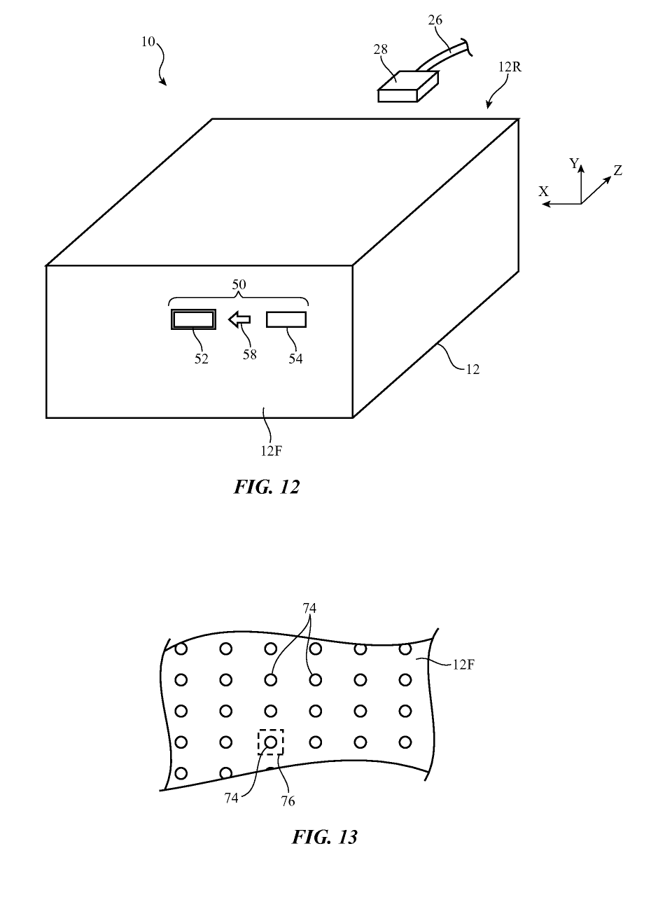

The presence of occupied (and therefore unavailable) ports such as the first port of FIG. 10 may be visually represented as part of alignment assistance information 50. If desired, unavailable ports may be grayed out or completely hidden from view. In the example of FIG. 11, ports 30 include five ports. Port location information such as port location indicators 52-1, 52-3, and 52-4 may show the location of four available ports. A fifth port (in this example) is occupied by a plug and is therefore not available for use by plug 28. Accordingly, no visual information is displayed corresponding to the location of the unavailable port (i.e., a gap such as gap 72 is present where the occupied port is located). By suppressing information on the location of the unavailable port, the information that is presented to the user is simplified and the user is discouraged from attempting to insert plug 28 into an unavailable port.

If desired, port location information can be suppressed or can include information indicating that the port is occupied (e.g., the X of FIG. 10) based on a mismatch between plug 28 and the type of input-output ports on device 10. If, for example, there is one USB port and one Ethernet port on device 10, device 10 can recognize which type of plug 28 is being aligned by the user. If, for example, device 10 senses that a USB-type plug is being aligned, the location corresponding to the USB port on device 10 can be indicated to be available and the location corresponding to the Ethernet port may be indicated to be unavailable. Plug type can be recognized by processing images of plug 28 that are captured in real time by device 10 using one or more rear facing cameras or other input devices.

In devices such as set-top boxes, desktop computers, and other equipment that does not include an internal display, it may be desirable to provide the device with the ability to display visual connector alignment assistance information. Visible connector alignment assistance 50 may be displayed using visual output components such as light-emitting diodes. As an example, an array of light-emitting diodes may be mounted on front face 12F of housing 12 or other portion of housing 12 in device 10. As the user aligns plug 28 with input-output port on rear face 12R of housing 12, the array of light-emitting diodes may be used to display visual plug alignment assistance information 50 (e.g., plug location indicator 54, input-output port location indicator 52, direction indicator 58, etc.). Visual assistance information 50 may be presented using a small number of light-emitting diodes (e.g., one, two, or three or more light emitting diodes of one or more colors) or may be represented using a larger array of multiple light-emitting diodes (e.g., a light emitting diode array having multiple rows and columns such as tens or hundreds of rows and/or columns).

Light-emitting diodes in the array may be mounted behind a plastic window in a metal housing, behind clear windows in an opaque plastic housing, within holes in housing 12, on external portions of housing 12, or using other suitable mounting techniques. As an example, housing 12 may have a portion such as front wall 12F of FIG. 13 that contains an array of perforations 74. Perforations may be laser-drilled or machined holes in an aluminum enclosure or other housing structure (as an example). Perforations 74 may be rectangular, circular, may have straight edges, may have curved edges, and/or may have a combination of straight and/or curved edges. The lateral dimensions of perforations 74 may be relatively large (e.g., 1-2 mm, more than 1 mm, etc.) or may be small (e.g., less than 1 mm, less than 100 microns, or less than 20 microns). In configurations in which the lateral dimensions of perforations 74 are relatively small (e.g., 20 microns or less), perforations 74 may be invisible to the naked eye. Small perforations may sometimes be referred to as microperforations. Microperforations may be visible or invisible to the naked eye. A light-emitting diodes such as illustrative light-emitting diode 76 of FIG. 13 may be mounted within device 10 behind the inner surface of wall 12F in alignment with a respective perforation 74. Light-emitting diodes such as diodes 76 may be mounted on a flexible printed circuit or other substrate in device 10 (as an example).

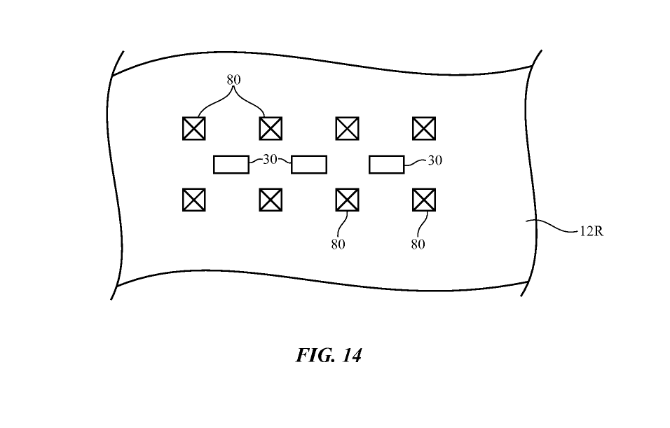

To determine the location of plug 28 relative to input-output ports 30, device 10 may include sensors and/or other equipment that can gather information on the location of plug 28 in real time. As shown in FIG. 14, for example, there may be input devices such as one or more plug location gathering components 80 in the vicinity of input-output ports 30 on rear housing wall 12R. In the example of FIG. 14, there are three input-output ports 30 and eight nearby location-information-gathering components 80. This is merely illustrative. There may be any suitable number of input-output ports on rear wall 12R (e.g., one, two, three, four or more, etc.). Moreover, there may be any suitable number of location-information-gathering components 80 (input devices) that monitor plug 28 as plug 28 is being aligned with port(s) 30 (e.g., one component 80, two components 80, three or more components 80, etc.).

Components 80 may include light-based proximity sensor, capacitive proximity sensors, light sources, light detectors, acoustic sensors (e.g., acoustic proximity sensing devices that include one or more tone generators such as ultrasonic tone generators and one or more microphones to detect reflected ultrasonic signals), cameras and other imaging systems for capturing two-dimensional and/or three-dimensional images, accelerometers or other components that can detect motion and device orientation relative to the Earth, magnetic sensors, thermal sensors, resistive sensors, switches (e.g., switches that switch from open to closed or from closed to open upon application of pressure), or other equipment for gathering information on the location of plug 28. The information that is gathered on plug 28 may include information on the lateral alignment of plug 28 relative to port(s) 30 (e.g., distance in X and Y relative to port(s) 30), orientation (e.g., whether plug 28 is oriented properly or is flipped 180° with respect to port 30), rotational alignment (e.g., whether rotational adjustments to plug position are needed), and distance (in dimension Z) between plug 28 and port 30. In some systems, coarse information may be detected (e.g., whether plug 28 is closer to a first port or a second port). In other systems, more fine-grained information may be gathered. For example, device 10 can accurately measure how far plug 28 is located away from port 30, so that alignment assistance information 50 can include an accurate visual representation of the location of plug 28 relative to the location of port 30.

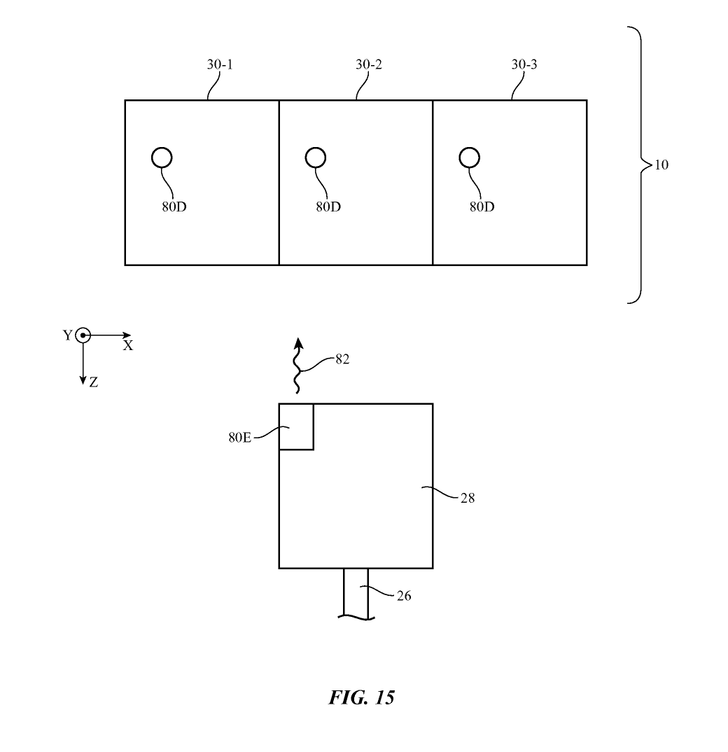

Device 10 and include sensors and other equipment for measuring the location of plug 28 without the active participation of components on plug 28 or one or more portions of plug 28 may be configured to help device 10 determine the location of plug 28. As shown in FIG. 15, for example, plug 28 may have a component such as component 80E that emits signals 82 that are used by device 10 in determining the location of plug 28. Components in device 10 such as detectors 80D in respective input-output ports such as input-output ports 30-1, 30-2, and 30-3 may be used to measure signals 82 and thereby determine the location of plug 28 relative to ports 30-1, 30-2, and 30-3. In the example of FIG. 15, there is one signal emitting component 80E and multiple signal detection components 80D, but this is merely illustrative. There may be more than one components 80E that emits signals 82 and there may be only a single detector 80D, two or more detectors 80D, or three or more detectors 80D.

Emitter 80E may emit static or dynamic magnetic fields (e.g., emitter 80E may be a permanent magnet or an electromagnet), may emit radio-frequency signals, may emit other electromagnetic signals, may emit light, may emit visible light, may emit infrared light, or may supply other signals 82. Detectors 80D may be detectors that detect and measure signals 82. For example, if signals 82 are static magnetic signals, detectors 80D may be magnetic sensors. If signals 82 are light signals (e.g., fixed or modulated infrared signals), detectors 80D may be photodetectors that are sensitive to infrared light. During operation, the strength of the signals from sensors 80D may be detected and compared. The respective signal strength from each detector 80D may be used to determine where plug 28 is located relative to the ports in which detectors 80D are located. Optical sensors (e.g., optical detectors 80D, optical emitters 80E, etc.) may operate at visible wavelengths and/or infrared wavelengths.

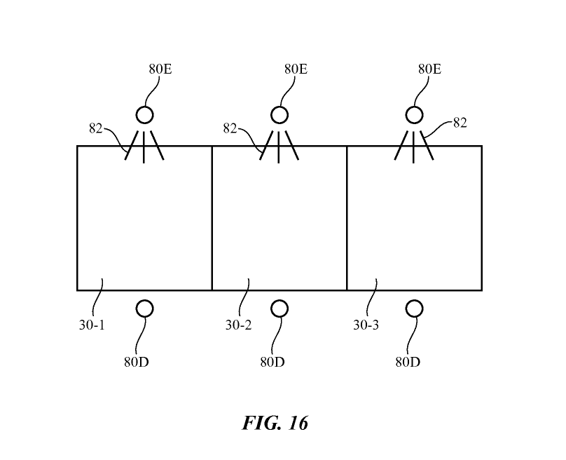

In the illustrative configuration of FIG. 16, signal emitters 80E are used to emit signals 82 in the vicinity of input-output ports 30-1, 30-2, and 30-3. Each emitter 80E may be associated with a respective port. One or more detectors 80D may be used to measure signals 82. Emitters 80E may be light emitters. Detector(s) 80D may be photodetectors that measure emitted light 82. When the light from a particular emitter is blocked, device 10 can determine that plug 28 is located in proximity to the port associated with that emitter. If desired, signals 82 may be encoded. For example, binary codes, pulse-width-based codes, frequency-based codes, amplitude-based codes, phase-based codes, or other unique signatures may be imposed on the emitted signals 82 for each port. If emitter 80E is a light source such as a light-emitting diode or laser, for example, binary codes may be used to turn on and off the light source in a particular pattern and each port may have a unique code. Detector(s) 80 may monitor incoming signals. By comparing the relative strengths of each of the received signals, device 10 can determine which emitters 80E are being blocked by the presence of plug 28 and therefore can determine the location of plug 28 relative to each port.

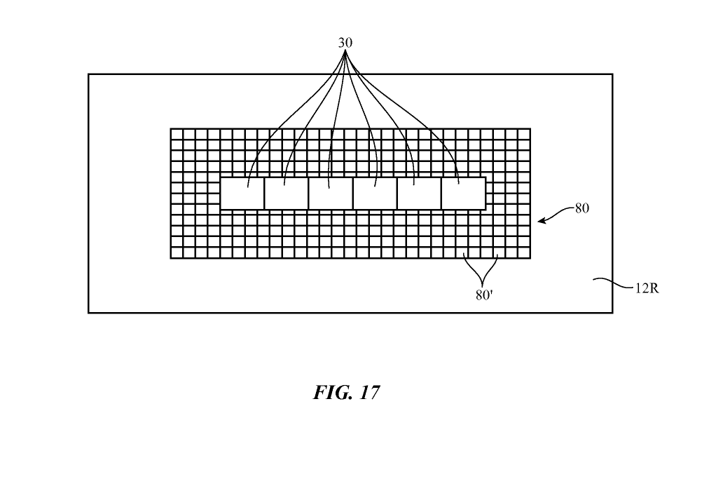

In the example of FIG. 17, part of rear housing surface 12R of housing 12 in device 10 has been covered with a sensor based on a grid of sensor elements such as sensor grid 80. Grid 80 may have sensor elements 80′. Sensor elements 80′ may be capacitive sensors (e.g., capacitive touch sensors), may be light-based sensors (e.g., emitter-detector pairs such as infrared light-emitting diodes and corresponding photodetectors), may be metal electrodes that can be shorted together when contacted by metal in plug 28, may be touch sensors (e.g., sensors that can detect when and where plug 28 has pressed against rear housing 12R), may be forece sensors, may be acoustic sensors, or may be other sensors. Device 10 can monitor signals from sensor array 80 to determine the location of plug 28 relative to ports 30.

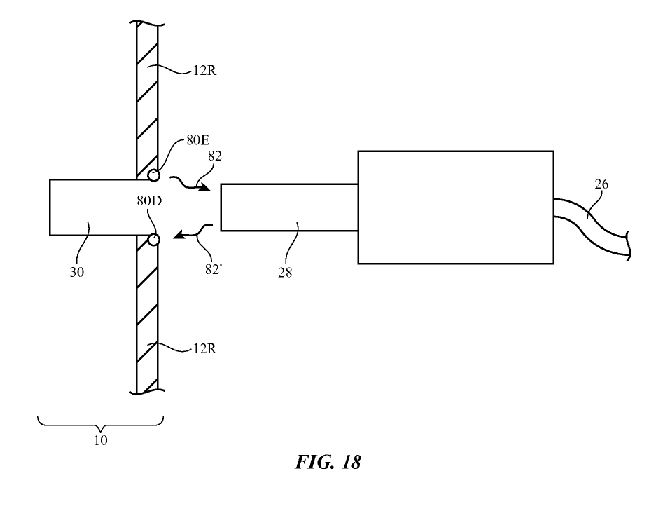

As shown in FIG. 18, device 10 may have sensors that emit signals that are reflected backwards to device 10 from plug 28 (when plug 28 is present in the vicinity of device 10. Device 10 of FIG. 18 may include, for example, a signal emitter such as emitter 80E that emits signals 82. Signals 82 may reflect from plug 28 towards signal detector 80D as reflected signals 82′. Signals 82 and 82′ may be light (e.g., infrared light), acoustic signals (e.g., ultrasonic signals), encoded signals, unencoded signals, etc. In configurations in which emitter 80E is a light source, emitter 80E may contain a visible or infrared light-emitting diode and detector 80D may include a photodetector. In configurations in which emitter 80E is an emitter of acoustic signals, emitter 80E may be a speaker, an ultrasonic tone generator, other tone generator components, or other sources of sound and detector 80D may be a microphone.

In configurations for device 10 that include multiple input-output ports 30, there may be a separate emitter-detector pair for each port. The presence or absence of plug 28 at each port can be monitored by comparing the signal strengths associated with each emitter-detector pair. If desired, coverage may be provided using more emitter-detector pairs that input-output ports or fewer emitter-detector pairs than input-output ports. Configurations in which emitters and/or detectors are shared among multiple ports may also be used (e.g., a single microphone may be used to gather reflected acoustic signals from multiple different ultrasonic tone sources or a single detector may monitor reflected light from multiple different light-emitting diodes, a single light source may produce light that is reflected into multiple different detectors, a single tone generator may generate ultrasonic signals that are received by multiple microphones, etc.).

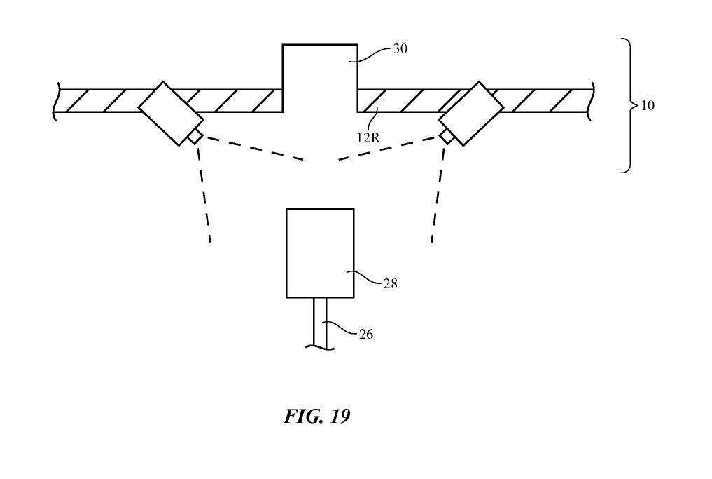

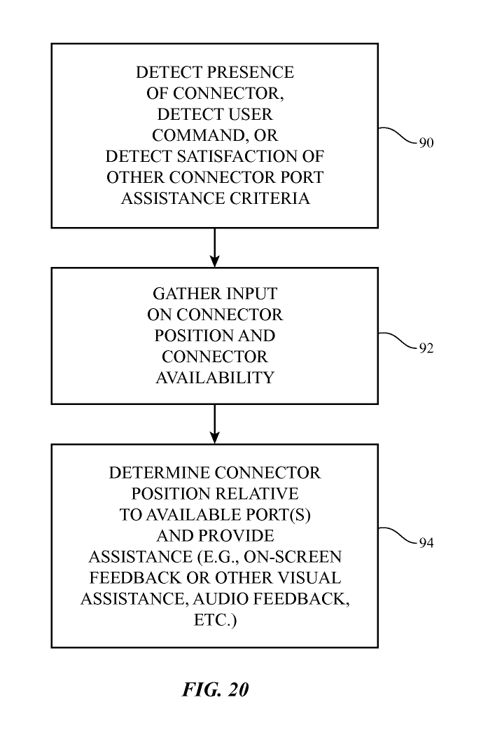

If desired, one or more cameras may be used in monitoring the location of plug 28, as illustrated by cameras 80D in device 10 of FIG. 19. With one configuration, a single two-dimensional camera may be used to capture digital images of plug 28. Device 10 may maintain a database of plug shapes. During image processing operations, the captured digital images of plug 28 may be compared to the database of plug shapes to determine how far plug 28 is located from device 10, to determine whether plug 28 should be flipped to orient plug 28 properly with respect to port 30, to determine whether rotational adjustments should be made, and to determine whether plug 28 should be laterally translated to bring plug 28 into alignment with port 30. If desired, two two-dimensional digital cameras may be used to capture image data on plug 28. When two cameras are used, stereo (three-dimensional) images may be captured. A multi-camera stereoscopic system therefore can serve as a type of three-dimensional camera system. Three-dimensional camera systems may also be used that illuminate nearby objects (e.g., objects such as plug 28 at the rear of device 10) with patterned infrared light and that use a two-dimensional camera to detect the reflected patterned infrared light. Upon processing the reflected light, a three-dimensional image of plug 28 can be reconstructed. Device 10 can use information on the location of plug 28 in three dimensions (from a two-dimensional camera, from a stereoscopic camera system, or from a near-infrared three-dimensional camera system, etc.) to provide plug alignment assistance information for the user (e.g., by displaying visual alignment assistance, etc.).

FIG. 20 is a flow chart of illustrative steps involved in using device 10 to provide a user with connector (plug) alignment assistance as the user mates plug 28 with an appropriate one of input-output ports 30. Input-output ports 30 may be located on the rear of device 10 (e.g., on rear housing wall 12R of housing 12), may be located on the lower edge of housing 12, may be located on other portions of device 10 in which it is difficult or impossible for a user to view plug 28 and/or input-output ports 30 during the process of aligning and mating plug 28 with an appropriate input-output port, or may be located on other suitable portions of device 10.

At step 90, device 10 (control circuitry 32) may detect the presence of plug (connector) 28. For example, the resources of input-output devices 34 (e.g., a sensor, camera, etc.) may detect that plug 28 is present in the vicinity of input-output ports 30. A user may also manually invoke connector alignment assistance functions on device 10 (e.g., by selecting an on-screen option, by supplying device 10 with a voice command, by entering information into a keyboard or other input-output device, etc.). If desired, device 10 (control circuitry 32) may also automatically invoke connector alignment assistance operations based on other criteria (e.g., detecting that a peripheral is present in the vicinity of device 10 through a wireless link, detecting that new hardware is being added to device 10, detecting that device 10 has been powered up, etc.). During connector alignment assistance operations, device 10 (e.g., control circuitry such as storage and processing circuitry 32) may use input-output devices 34 to gather input and supply output to a user. Output may be supplied visually (e.g., using display 14, using an array of light-emitting diodes such as diodes associated with perforations in housing 12, using status indicator lights, etc.), may be supplied using sound (e.g., audible output may be provided using speakers, tone generators, voice synthesis equipment, audio clip playback circuitry, etc.), or may be supplied using both visible and audio output arrangements.

At step 92, control circuitry 32 may use an input device in input-output devices 34 to gather input on the position of plug 28. Control circuitry 32 may, for example, use sensor(s), camera(s), or other input devices in input-output devices 34 to monitor the location of plug (connector) 28. Information may be gathered on the position of plug 28 in dimensions X, Y, and, if desired, dimension Z. Information may also be gathered on the rotational alignment of plug 28 relative to input-output ports 30. Control circuitry 32 may identify the type of plug that is being plugged into input-output ports. Using information on data traffic, connector sensors, or other equipment, control circuitry 32 can identify which input-output ports 30 are available for use by the user. Port availability can be based on the type of plug being presented to device 10 (i.e., only available USB ports can be identified in response to determining that plug 28 is a USB port), available ports can be based on which ports are currently unoccupied by connectors, etc.

At step 94, control circuitry 32 may determine the location of plug 28 relative to the available input-output ports 30 of device 10. If, for example, a single USB port is available for use by a USB plug, control circuitry 32 can determine the location of the USB plug relative to that USB port. Once the location of plug 28 relative to each available port has been determined, control circuitry 32 can provide the user with plug alignment assistance information. Assistance for inserting connector 28 into available input-output ports 30 may be provided visually (e.g., by displaying identifiers or other information on display 14 or an array of light-emitting diodes on housing front face 12F), may be provided using audio information (e.g., by playing instructions or other audio information for the user through speakers), etc. The plug (connector) alignment assistance information preferably provides the user with information on how plug 28 can be translated and/or rotated so that plug 28 can be brought into proper alignment with a given one of the available input-output ports (i.e., the alignment assistance can help the user align and mate plug 28 with an appropriate input-output port 30). The user need not view input-output port 30 directly during the plug alignment process, because the sensor circuitry, camera equipment, or other resources of input-output devices 34 can guide the user even when plug 28 and the input-output ports of device 10 are blocked from view.

The foregoing is merely illustrative and various modifications can be made by those skilled in the art without departing from the scope and spirit of the described embodiments. The foregoing embodiments may be implemented individually or in any combination.

What is claimed is:

1. An electronic device operable with an external accessory having a plug, comprising:
a housing;
an input-output port in the housing that is configured to mate with the plug;
control circuitry;
an input device that is used by the control circuitry to gather information on where the plug is located relative to the input-output port; and
an output device that is used by the control circuitry to provide a user of the electronic device with plug alignment assistance information.

2. The electronic device defined in claim 1 wherein the output device comprises a visual output device and wherein the plug alignment assistance information includes visual information indicative on how the plug is currently positioned with respect to the input-output port.

3. The electronic device defined in claim 2 wherein the input device comprises a sensor that monitors where the plug is located.

4. The electronic device defined in claim 3 wherein the sensor comprises a proximity sensor.

5. The electronic device defined in claim 3 wherein the sensor comprises a capacitive sensor.

6. The electronic device defined in claim 4 wherein the sensor comprises a light-based sensor.

7. The electronic device defined in claim 2 wherein the input device comprises a camera that monitors where the plug is located.

8. The electronic device defined in claim 7 wherein the input device comprises a stereo camera system having two cameras to monitor where the plug is located.

9. The electronic device defined in claim 7 wherein the input device comprises a three dimensional camera.

10. The electronic device defined in claim 2 wherein the visual output device comprises a display on which the visual information indicative on how the plug is currently positioned with respect to the input-output port is displayed.

11. The electronic device defined in claim 2 wherein the visual output device comprises a light-emitting diode array on which the visual information indicative on how the plug is currently positioned with respect to the input-output port is displayed.

12. The electronic device defined in claim 2 wherein the visual output device comprises a display, wherein the visual information includes an input-output port location indicator indicative of where the input-output port is located, and wherein the visual information includes a plug location indicator indicative of where the plug is located.

13. The electronic device defined in claim 2 wherein the visual output device comprises a display, wherein the visual information includes an input-output port location indicator indicative of where the input-output port is located, wherein the visual information includes a plug location indicator indicative of where the plug is located, and wherein the visual information includes information instructing the user how to move the plug to bring the plug into alignment with the input-output port.

14. The electronic device defined in claim 1 wherein the input-output port comprises one of a plurality of input-output ports and wherein the control circuitry is configured to identify which of the plurality of input-output ports are of a type that mates with the plug.

15. The electronic device defined in claim 1 wherein the input-output port comprises one of a plurality of input-output ports and wherein the control circuitry is configured to identify which of the plurality of input-output ports is available to mate with the plug.

16. The electronic device defined in claim 15 wherein the output device comprises a visual output device and wherein the plug alignment assistance information includes visual information indicative of which of the plurality of input-output ports is available to mate with the plug and which of the plurality of input-output ports is not available to mate with the plug.

17. A method of providing a user with plug alignment assistance to help the user insert the plug into an input-output port in an electronic device, comprising:
using an input device in the electronic device to gather information on where the plug is located relative to the input-output port;
with control circuitry in the electronic device, determining how the user should move the plug to align the plug with the input-output port; and
providing plug alignment assistance information to the user with an output device in the electronic device, wherein the plug alignment assistance information indicates how the user should move the plug to align the plug with the input-output port.

18. The method defined in claim 17 wherein using the input device comprises using at least one camera to gather the information on where the plug is located relative to the input-output port.

19. The method defined in claim 18 wherein the electronic device includes a display and wherein providing the plug alignment assistance information comprises displaying information on the display informing the user that the plug should be rotated to align the plug with the input-output port.

20. An electronic device, comprising:
a housing having a front and a rear;
a display mounted at the front of the housing;
an input-output port at the rear of the housing, wherein the input-output port is configured to receive a mating plug of an external accessory;
input-output devices; and
control circuitry that uses the input-output devices to determine where the plug is located with respect to the input-output port and that displays plug alignment assistance information on the display that indicates how the plug should be moved to align the plug with the input-output port.
